(19) United States
(12) Patent Application Publication
(10) Pub. No.: US 2011/0127249 A1
(43) Pub. Date: Jun. 2, 2011

(54) ELECTRIC HEATING ELEMENT FOR INSOLES

(75) Inventor: Daniel Lopez TENIAS, Vilters (CH)

(73) Assignee: Hotronic International Limited, Central (HK)

(21) Appl. No.: 12/626,771

(22) Filed: Nov. 27, 2009

(51) Int. Cl. H05B 3/00; A43B 7/02; A43B 7/04

(52) U.S. Cl. 219/211; 36/2.6; 36/43

(57) ABSTRACT

There is described an electric heating element for insoles of footwear is provided which comprises a flexible, generally flat sheet of material. The sheet of material is provided across its surface with heating means. The heating means is connected with a number of flat electrodes for electric direct current, and includes positive and negative electrodes which are electrically connectable to a positive and a negative power line, respectively. The heating means is of a planar, continuous configuration and adapted to produce heat when electric direct current flows therethrough.

### FIELD OF THE INVENTION

The present invention relates to an electric heating element for insoles as used in footwear. The invention further relates to an electric heating insole system that can be freely installed in footwear and generate a heating function under user control.

### BACKGROUND OF THE INVENTION

Many sports and other activities are conducted outdoors under cold and perhaps harsh conditions. Examples include but are not limited to snow skiing and snow boarding, ice skating, hinting, ice fishing, etc. Also many professions involve exposure to similar cold conditions. In each circumstance the body will respond to cold temperatures by directing the blood flow such that the core body temperature is maintained. This may result in discomfort in the extremities, i.e., the feet.

From the prior art a number of products are known which are designated to provide warmth and comfort for the feet, among them heating insole systems which may be installed and inserted in footwear, such as, e.g., in skiing and snow boarding boots, ice skating shoes, moon boots, and other kinds of outdoor footwear. In US 2006/0201025 A1 a heating insole system is described which consists of an insole having at least two layers of heatproof fabrics with an electro-thermal structure emplaced between the two layers. The electro-thermal structure consists of a resistance heating, which extends uniformly across the area of the insole. The electro-thermal structure is connected to a control circuit and a battery thereby constituting an electric loop. The technical design of this known heating insole system is such, that fits one size of shoe only. Thus, for every different shoe size a separate heating insole must be held on stock. Trimming of the insole is hardly possible because of the danger that the electro-thermal resistance heating structure is damaged or destroyed.

From U.S. Pat. No. 6,657,164 B1 a heating insole system is known which overcomes the aforementioned disadvantages by providing a cushioned footwear insole which in its lower face has a receptacle for a flat basically two-dimensioned heating element of standardized size. The receptacle is provided in a forefoot region of the insole and communicates with a shallow elongated channel which extend to the heel area and is designed to accommodate a flexible power cable of the heating element. The flexible power cable is connected with an electric power supply including a control circuit. The heating element comprises a number of, such as, e.g. three, discrete resistors or like discrete heat producing elements which are coupled in series, and which produce heat when electric current is run therethrough. The heating element of standardized dimensions may be combined with insoles of different sizes. Also the insole may be trimmed fit exactly into the footwear with any risk of damaging or destroying the heating element. Thus, the retailer need not keep on stock insoles and heating elements for every footsize. It is sufficient if e.g. only a certain number of small, medium size and large insoles are kept on stock which may be trimmed to exact size only upon sale. There is only one type of heating element required, which may be combined with any insole. While this known heating insole system proves convenient, both, for the retailer and for the customer, the discrete resistors or like discrete heat producing elements of the heating element, which produce the heat, may become a source of discomfort for the customer. A person having very sensitive footsoles or being of great weight may in use feel the physical presence of the resistors or other discrete heat producing elements. Also the heat producing elements, which are interconnected in series, form discrete heat sources, which for persons with very sensitive footsoles may seem uncomfortable. It is therefore an object of the present invention to address these possible sources of discomfort of the heating sole systems of the prior art.

### SUMMARY OF THE INVENTION

In accordance with the invention an electric heating element for insoles of footwear is provided which comprises a flexible, generally flat sheet of material. The sheet of material is provided across its surface with heating means. The heating means is connected with a number of flat electrodes for electric direct current, and includes positive and negative electrodes which are electrically connectable to a positive and a negative power line, respectively. The heating means is of a flat, continuous configuration and adapted to produce heat when electric direct current flows therethrough. The electric heating means according to the invention addresses the problems of discrete resistors or like discrete heat producing elements which may be the cause of inconvenience to persons having very sensitive footsoles. The electric heating means is of a completely flat structure and thus is not noticed by the user. The heat is produced across a larger surface area and is distributed more evenly, so that discrete “hot spots” are avoided, thereby improving the feeling of comfort of the user. Because of the flat and areal configuration of the heating means mechanical strain due to the weight of the user is distributed across a greater area. Thus, the danger of defects of discrete heating elements and of the connections thereof is largely reduced.

In an embodiment of the electric heating element the heating means comprises at least one flat, planar heating area which is covered with an electrically resistive coating. The electrically resistive coating may be applied to the flat sheet of material in a rather thin coating, so that the overall thickness of the electric heating element may be kept rather low. The electrically resistive coating is very homogenous and supports a uniform production of heat when electric direct current flows therethrough.

In another embodiment of the electric heating element the heating means comprises a number of said heating areas which are all evenly covered with the electrically resistive coating, and the heating areas are electrically connected with each other in series. In an alternative embodiment of the electric heating element the heating means again comprises a number of said heating areas which are covered with said electrically resistive coating. In this alternative embodiment the heating areas are connected with each other in electrically parallel configuration. Both, the serial and the parallel arrangement, allow for an easy trimming of the heating areas, which are configured as planar resistors. The trimming of the planar resistors may be accomplished, e.g., with a laser. It may be performed during the manufacturing of the heating element, in order to achieve very steady result. The trimming of the planar resistors may also be used to produce planar resistors having different resistance values, and thus to achieve heating areas which produce more or less heat across the surface of the heating element.

An embodiment of the electric heating element having a number of heating areas is provided across its surface with a number of flat electrodes for direct current, which electrodes are divided into a group of positive electrodes and into a group of negative electrodes. The electrodes of each one of the two groups are in parallel connection with each other and are electrically connected to a positive or negative power line, respectively, of a flexible power cable which may be connected with an electric power source for direct current. The positive and negative electrodes, in pairs, delimit and electrically contact an areal portion of the sheet material which is covered with an electrically resistive coating. The heat producing means are planar resistor fields which are electrically connected parallel with each other. Each one of the flat resistor fields basically consists of a pair of electrodes, namely a positive and a negative electrode, which delimit and electrically contact an areal distribution of a resistance coating. The completely flat configuration of the resistor fields avoids vertically protruding individual structures. When the electrodes are connected with the electric power source the parallel resistor fields produce heat across the whole extension of the heating element.

In another embodiment of the electric heating element the sheet of material is a piece of a printed circuit board and the groups of positive and negative electrodes are provided on the surface thereof as conductive paths of copper. For the manufacture of the piece of printed circuit board with conductive paths conventional technologies, such as, e.g., etching, printing, etc., may be applied. The piece of printed circuit board may have any shape, though regular shapes, such as, e.g., circular, elliptic, oval, or rectangular shapes, are preferred.

In still another embodiment of the heating element according to the invention the positive and negative electrodes are distributed alternately across the surface of the sheet material, e.g. the piece of electric circuit board. The electrodes extend generally from a periphery of the sheet material towards a central portion thereof and are entirely covered by the electrically resistive coating.

A further embodiment of the electric heating element according to the invention provides, that the areal portions which are delimited between pairs of positive and negative electrodes, have approximately the same size. With this configuration it is ensured that the flat resistor fields display the about same electric resistance and in use develop the about same amount of heat which is equally evenly distributed across the area of resistor fields.

In another embodiment of the invention the electrically resistive coating is a layer of polymer-resistive paste comprising carbon, which is evenly distributed across the surface of the printed circuit board and covering the electrodes. Such polymer-resistive paste is commercially available, e.g., from Electra, Roughway Mill, Dunk's Green, Tonbridge, Kent TN11 9SG, England under the tradename Electa^{Ω}D'OR ED 75000 Series. The resistive paste is easy to handle in manufacture and has the required mechanical properties for an application in an electric heating insole system. For additional protective purposes the layer of resistive paste is covered with a layer of a solderstop mask.

A further embodiment of the electric heating element according to the invention comprises a copper layer evenly distributed across a surface of said sheet material which is opposite to said surface bearing said electrodes. The copper layer enhances the even distribution of the heat produced by the resistor fields on the opposite side of the sheet material, i.e. the piece of printed circuit board.

An electric heating insole system for use in footwear according to the invention comprises a flexible, cushioned footwear insole of extended length with a forefoot region and a heel region. The insole has a bottom surface which is provided with a closable receptacle for accommodating an electric heating element in accordance with any one of the embodiments described above. The insole is further being provided in the bottom surface with a channel extending from the receptacle for the heating element to the heel region for accommodating a flexible electric power cable which is adapted to be connected with an electric power source for direct current. In the electric heating insole system according to the invention the insole and the heating element are separate components which may be assembled to a system as desired. The retailer needs to keep on stock only a limited number of heating elements which all have a standardized size. The insoles may be shaped to any foot size, or they may be provided only, e.g., in small, medium, and large size. The retailer or the customer may upon sale trim the insole to the exact required size and shape in accordance with the designated footwear. This is an improvement for both, the retailer and the customer. The retailer need not keep in stock large numbers of insoles and heating elements, and the retailer or the customer may trim the insole exactly to the required shape, which enhances comfort for the wearer of the footwear.

In an embodiment of the electric heating insole system the electric power source is a battery power pack comprising at least one rechargeable battery and further being provided with a control circuit. The control circuit controls temperature and regulates the power supply accordingly. It further may be provided with a power management system, which enhances the life of the power pack. The rechargeability of the battery pack takes into account environmental aspects.

### BRIEF DESCRIPTION OF THE DRAWINGS

These and still further features and advantages of the electric heating element and the electric heating insole system will become apparent from the following description of exemplary embodiments of the invention, reference being made to the schematic drawings which are not to scale, in which:

FIG. 1 is a top plan view of a heating element;

FIG. 2 is a top plan view of the material sheet and electrodes of the heating element of FIG. 1;

FIG. 3 is an underneath plan view of the heating element of FIG. 1;

FIG. 4 is a sectional view of the heating element of FIG. 1; and

FIG. 5 shows an electric heating insole system.

### DETAILED DESCRIPTION

The following description of exemplary embodiments of the invention is for illustrative purposes only and is not intended to limit of the scope of the invention.

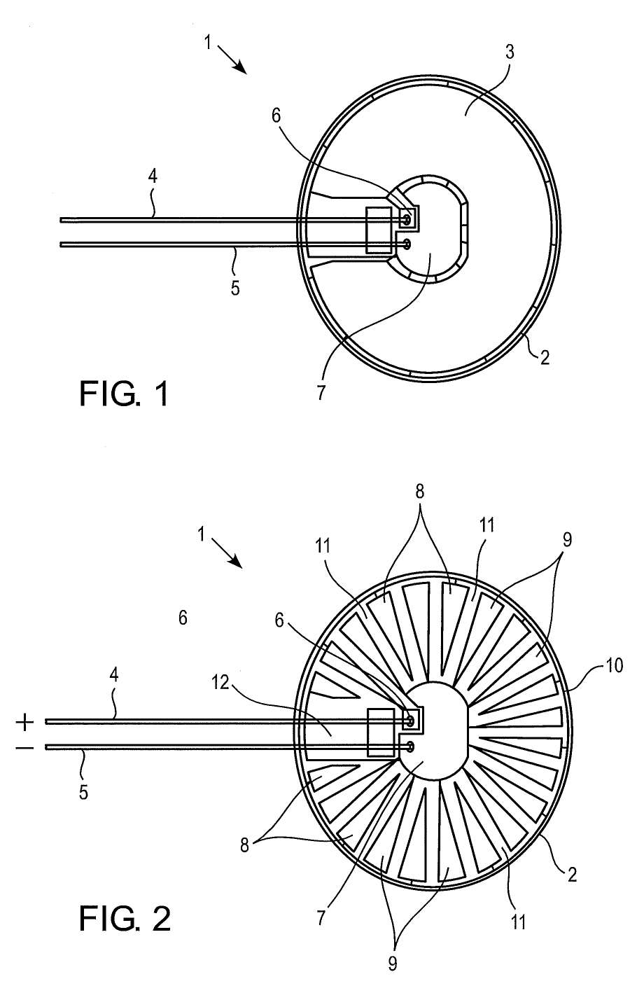

In FIGS. 1 and 2 a heating element is generally designated with reference numeral 1. The heating element comprises a flat material sheet 2 with electrodes 8 and 9 distributed across the surface of the material sheet 2 (FIG. 2). In a specific embodiment the heating element comprises a piece of a printed circuit board, which is made of a sheet of electrically isolating material, usually a fiber reinforced resinous structure, with electric conductors on one of its surfaces. The electric conductors, i.e. the electrodes 8, 9, are established e.g. by appropriate etching of a layer of copper which has been deposited on the basic material sheet 2. At the completed heating element, which is depicted in FIG. 1, the electrodes are entirely covered with an electrically resistive coating 6, such as, e.g., a polymer-resistive paste comprising carbon, which is available from Electra, Roughway Mill, Dunk's Green, Tonbridge, Kent TN11 9SG, England under the tradename Electa^{Ω}D'OR ED 75000 Series. The heating element 1 may have any desired shape. Preferably though, the heating element 1 is of a regular shape, such as circular, oval, rectangular or—as depicted—elliptic. The heating element 1 is electrically connected with electric lines 4, 5, which are bonded or soldered to two separate contact pads 6, 7.

From FIG. 2 it is seen that the electrodes are divided into two groups of electrodes 8, 9, which in each group are connected with each other in parallel relationship. E.g. the electrodes 8 form the group of positive electrodes 8 which are connected with contact pad 6, the smaller pad about in a central region of the material sheet 2. If the contact pad 6 is connected via positive electric line 4 with the anode of a source of direct current, pad 6 has a positive electric potential. A contact ring 10 at the periphery of the material sheet 2 provides contact to all positive electrodes 8. Electrodes 9 form a group of negative electrodes 9 which also are connected with each other in parallel relationship. The negative electric potential is provided by a large contact pad 7 in the central region of the material sheet 2, which via negative electric line 5 is connected with the cathode of a source of direct current.

Positive electrodes 8 and negative electrodes 9 are arranged on the surface of the material sheet 2 alternately. Each pair of a positive electrode 8 and an negative electrode 9 delimits an areal portion 11 on the material sheet 2. Each electrode 8 or 9 contacts two neighboring areal portions 11. When the electrode surface of the material sheet 2 is covered with the electrically resistive coating 6 (FIG. 1) the areal portions 11 form flat resistors which are delimited and electrically contacted by the positive and negative electrodes 8, 9. Due to the parallel connections of the positive and negative electrodes 8, 9, respectively, the flat resistors 11 are also electrically connected with each other in parallel configuration. The electrodes 8, 9 may be of any shape, as long as they are of flat configuration and as long as the alternating arrangement of positive 8 and negative electrodes 9 is maintained. In the embodiment depicted in FIG. 2 the electrodes 8, 9 have about the shape of segments of a circle. Due to this configuration of the electrodes 8, 9 the areal regions 11, which each are enclosed by a pair of electrodes 8, 9, have about rectangular shapes. According to the embodiment of FIG. 2 the areal regions 11 have about the same size, resulting in flat resistors having about the same resistance. When direct current provided via the delimiting and electrically contacting electrodes 2 flows through the resistors 11 they will develop about the same amount of heat. Finally, a region 12 underneath the electric lines 4, 5 is free from electrodes 8, 9. This region 12 may be used for attaching the electric lines 4, 5, which are usually provided in form of a two line flat cable, to the material sheet 2 such, that the bonding or soldering spots at which the electric lines 4, 5 are electrically and mechanically connected with the contacting pads 6, 7 may be kept free from mechanical stress.

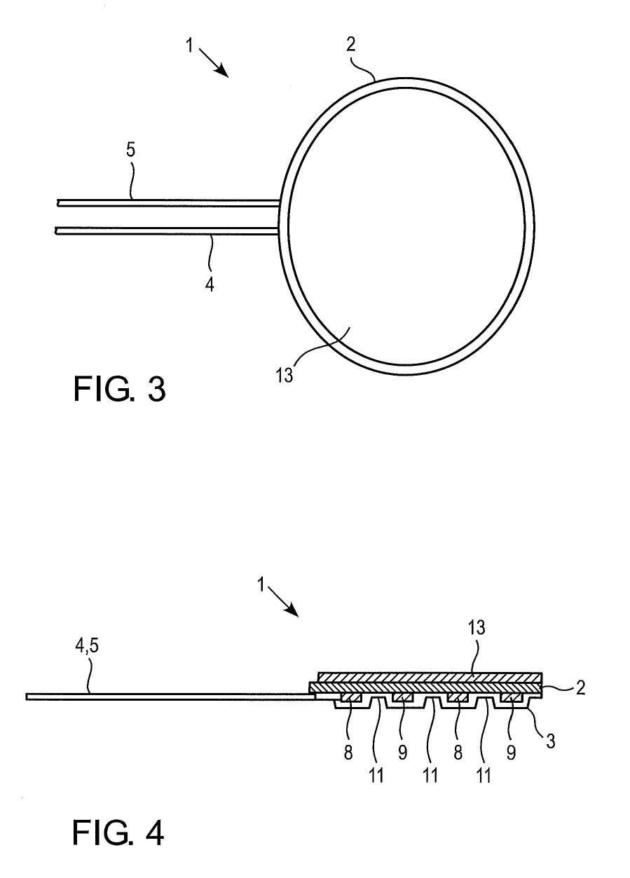

FIG. 3 shows the electric heating element 1 from underneath. The surface of the material sheet 2 opposite the electrodes is covered with a copper layer 13 which improves the heat distribution. The electric lines for connecting the groups of electrodes to a source of direct current are designated again with reference numerals 4 and 5.

FIG. 4 shows a schematic cross sectional view of the heating element 1. The heating element is depicted in its position of use, in which its underneath surface with the copper coating 13 faces upward. The basic sheet of isolating material is designated with reference numeral 2. The alternating positive and negative electrodes are indicated at 8 and 9, respectively. The electrodes 8, 9 are covered with electrically resistive coating 3. Each coated area delimited and electrically contacted by a pair of electrodes 8, 9 forms a resistor 11. The electrodes 8, 9 are contacted by electric lines 4, 5. The material sheet 2 has a thickness which amounts to about 0.27 mm to 0.33 mm. The height of the electrodes 8, 9, which are e.g. etched from a copper layer deposited in one side of the material sheet 2, amounts to about 0.35 μm to about 0.76 μm. The electrically resistive coating 3 has a thickness which amounts to about 50 μm to about 300 μm. The copper coating on the underneath surface of the heating element 1 has a thickness which amounts to about 0.35 μm to about 0.76 μm.

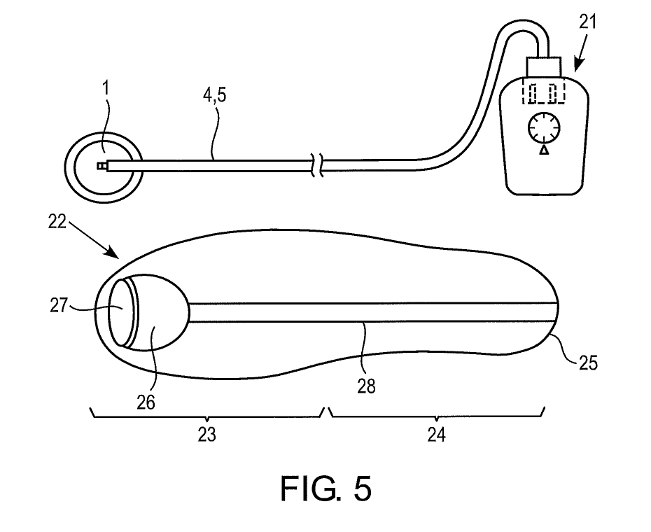

FIG. 5 shows schematically an electric insole heating system for use in footwear. The total system, which is designated with reference numeral 20 comprises as separate components a battery pack 21, a flexible cushioned insole 22, and a heating element 1 in accordance with the invention. The heating element 1 is connected via electric line 4, 5 with the battery pack 21 as source of direct current. Insole 22 is of generally foot shaped elongated configuration with a forefoot region 23 and a heel region 24. The heel end is designated with reference numeral 25. In the forefoot region 23 of the underneath side the insole is provided with a receptacle 26 for the heating element 1. A flap 27 is attached to the periphery of the receptacle 26 and serves as a closure for the receptacle 26. An elongated channel 28 extends from the receptacle 26 towards the heel region 24 and ends at the heel end 25 of the insole 22. The elongated channel 28 is adapted to receive the electric line 4, 5 of the heating element 1, which is accommodated in the receptacle 26. The insole 22 together with the inserted heating element 1 is placed into a footwear, such as, e.g., a skiing boot, with the underneath side thereof facing the inside bottom of the boot. The electric line 4, 5 is provided with an interface plug and is connected with the battery pack 21 which is provided with a corresponding interface plug. The battery pack 21 may, e.g., be attached to the rim of the skiing boot or be worn inside a pouch of the skiing pants, etc. The battery pack 21 may further be provided with a control circuitry for controlling temperature of the heating element and the energy consumption thereof.

The invention has been described in connection with an arrangement of alternating positive and negative electrodes which extend generally radially from a periphery of the sheet material towards the center thereof. It is to be noted that this configuration is for illustrative purposes only and that the invention is not limited to the depicted configuration. Rather, the electrodes may also be provided on the surface of the material sheet in alternative configurations, such as, e.g., in an interdigital configuration.

1. An electric heating element for insoles of footwear comprising a flexible, generally flat sheet of material, said sheet of material being provided across its surface with heating means, said heating means being connected with a number of flat electrodes for electric direct current, and including positive and negative electrodes which are electrically connectable to a positive and a negative power line, respectively, and said heating means being of a planar, continuous configuration and adapted to produce heat when electric direct current flows therethrough.

2. The electric heating element of claim 1, wherein said heating means comprises at least one flat, planar heating area which is covered with an electrically resistive coating.

3. The electric heating element of claim 2, wherein said heating means comprises a number of said heating areas which are covered with said electrically resistive coating, said heating areas being electrically connected with each other in series.

4. The electric heating element in claim 2, wherein said heating means comprises a number of said heating areas which are covered with said electrically resistive coating, said heating areas connected with each other in electrically parallel configuration.

5. The electric heating element of claim 4, where said sheet of material is provided across its surface with a number of flat electrodes for direct current, said electrodes forming a group of positive electrodes and a group of negative electrodes, the electrodes of each said group being in parallel connection with each other and being electrically connectable to a positive or negative power line, respectively, of a flexible power cable which is adapted to be connected with an electric power source for direct current, said positive and negative electrodes, in pairs, delimiting and electrically contacting an areal portion of the sheet material which is covered with an electrically resistive coating.

6. The electric heating element of claim 3, wherein said sheet of material is a piece of a printed circuit board and said electrodes are provided on the surface thereof as conductive paths of copper.

7. The electric heating element of claim 6, wherein said positive and negative electrodes are distributed alternately across the surface of said sheet material and extend generally from a periphery of said sheet material towards a central portion thereof, and wherein said electrically resistive coating covers said electrodes entirely.

8. The electric heating element of claim 7, wherein said areal portions which are delimited between pairs of said positive and negative electrodes, have approximately the same size.

9. The electric heating element of claim 8, wherein said electrically resistive coating is a layer of polymer resistive paste comprising carbon, which is evenly distributed across the surface of the printed circuit board and covering the electrodes.

10. The electric heating element of claim 9, further comprising a copper layer evenly distributed across a surface of said sheet material which is opposite to said surface bearing said electrodes.

11. Electric heating insole system for use in footwear comprising a flexible, cushioned footwear insole of extended length with a forefoot region and a heel region, and having a bottom surface which is provided with a closable receptacle for accommodating an electric heating element in accordance with claim 1, and further being provided in said bottom surface with a channel extending from said receptacle to said heel region for accommodating a flexible electric power cable which is adapted to be connected with an electric power source for direct current.

12. The electric heating insole system of claim 11, wherein, said electric power source is a battery power pack comprising at least one rechargeable battery and further being provided with a control circuit.

13. The electric heating element of claim 4, wherein said sheet of material is a piece of a printed circuit board and said electrodes are provided on the surface thereof as conductive paths of copper.

14. The electric heating element of claim 5, wherein said sheet of material is a piece of a printed circuit board and said electrodes are provided on the surface thereof as conductive paths of copper.
